(19) United States
(12) Patent Application Publication
(10) Pub. No.: US 2004/0117929 A1
(43) Pub. Date: Jun. 24, 2004

(54) Two layered electromotive tooth brush

(76) Inventors: Cheng Jen Lin, Taipei (TW); Mei Hui Lin, Taipei (TW)

Correspondence Address: Cheng Jen Lin, 235 Chung - Ho, Box 8-24, Taipei, TW

(21) Appl. No.: 10/322,034

(22) Filed: Dec. 19, 2002

(51) Int. Cl. A61C 17/26

(52) U.S. Cl. 15/23

(57) ABSTRACT

Accordingly, the primary object of the present invention is to provide a two layered electromotive tooth brush which comprises a casing, a connecting head, a positioning seat, a water-proof bush, an axial tube, an axial tube seat, an axial cover, a driving shaft and a brush. A switch unit is controlled to drive a motor to rotate. The rotary shaft of the motor causes the axial tube to rotate and the water-proof bush does not rotate so as to rotate the driving shaft. One end of the brush is connected to the driving shaft and another thereof is pivotally connected to the axial seat of the protecting mask. The brush is rotatable for brushing. Moreover, hairs of the brush have round cross section. In use, the hairs rotate through the round periphery instead of rotating leftwards or rearwards. Thereby, it has a better cleaning effect.

### FIELD OF THE INVENTION

The present invention relates to electromotive tooth brush, and particularly to a two layered electromotive tooth brush.

### BACKGROUND OF THE INVENTION)N

The prior art electromotive tooth brush has a single layered structure. In other words, it is a rod like shape. A motor, a driving shaft and a battery are used installed. Since it is a single layered structure, the tolerance is bad and it is easy to be damaged. Moreover, due to the single layered structure, it has a bad water-proof effect and water is easy to permeate into the tooth brush.

### SUMMARY OF THE INVENTION

Accordingly, the primary object of the present invention is to provide a two layered electromotive tooth brush which comprises a casing, a connecting head, a positioning seat, a water-proof bush, an axial tube, an axial tube seat, an axial cover, a driving shaft and a brush. A switch unit is controlled to drive a motor to rotate. The rotary shaft of the motor causes the axial tube to rotate and the water-proof bush does not rotate so as to rotate the driving shaft. One end of the brush is connected to the driving shaft and another thereof is pivotally connected to the axial seat of the protecting mask. The brush is rotatable for brushing. Moreover, hairs of the brush have round cross section. In use, the hairs rotate through the round periphery instead of rotating leftwards or rearwards. Thereby, it has a better cleaning effect.

Another object of the present invention is to provide a two layered electromotive tooth brush, wherein when it is desired to clean the brush, the axial cover of the axial tube seat is detachable. Likewise, if the brush is worn, the brush can be detached independently for updating.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled cross sectional view of the present invention.

### DETAILED DESCRIPTION OF THE PREFERRED EMBODIMENTS

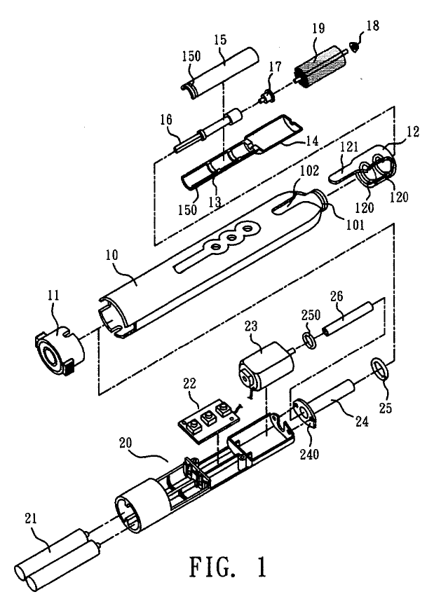

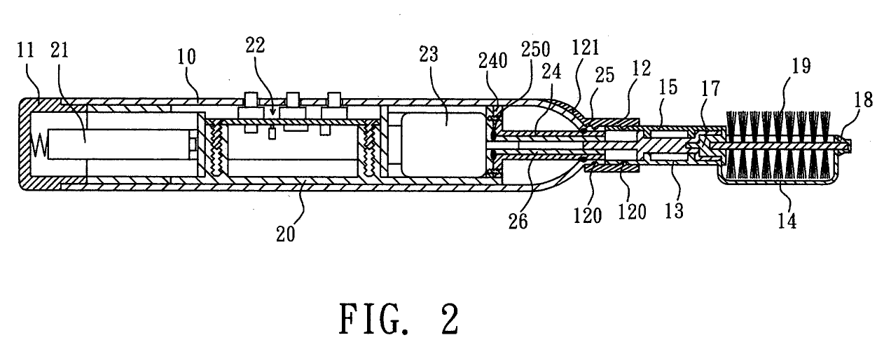

Referring to FIGS. 1 and 2, the present invention includes a casing 10, a connecting head 1, a positioning seat 20, a water-proof brush 24, an axial tube 26, an axial tube seat 13, an axial cover 15, a driving shaft 16 and a brush 19.

A rear end of the casing 10 has a sealing cover 11 and a front end thereof has an inserting slot 102 and an annular groove 101.

The connecting head 12 has an enhancing piece 121 at a rear end thereof and having a configuration with respect to the shape of the inserting groove 102 of the casing 10; and an inner wall thereof is formed with annular buckling strips 120 with a configuration with respect to the annular groove 101 of the casing 10.

The positioning seat 20 serves for installing a motor 23 and a switch unit 22 and then the positioning seat 20 is assembled into the casing 10 to be as a double layer structure.

The axial tube 26 is assembled to a rotary shaft of the motor 23 to be driven by the motor.

The water-proof brush 24 having a positioning piece 240 and a first washer 250 which is positioned within the water-proof brush 24. The water-proof brush 24 is engaged to the axial tube 26 so as to be as a double layer structure to assist the axial tube 26 to move along a straight line and enhance the tolerance of the axial tube 26. A periphery of the water-proof brush 24 is formed with a washer 25 to have a water-proof effect with the casing.

The axial tube seat 13 and the axial cover 15 are combined as an integral body. A driving shaft 16 is mounted within the axial tube seat 13, a front end of the axial tube seat 13 has a protecting mask 14 for receiving a brush 19 and a rear end thereof has an annular recess 150 for receiving the connecting head 12.

The driving shaft 16 is assembled to the axial tube seat 13 and the axial cover 15. A front end of the driving shaft 16 is inserted into the axial tube 26 as to rotate therewith and a rear end of the driving shaft 16 has a connector 17 for assembling the brush 19.

The brush 19 has a spindle. One end of the brush 19 is inserted into the connector 17 of the driving shaft 16 and another end thereof is assembled into an axial seat 18 of the protecting mask 14 of the axial tube seat 13 so as to be rotated by the driving shaft 16 synchronously. The brush 19 has round hairs around the spindle.

In operation of the present invention, as shown in FIG. 2, the switch unit 22 is controlled to drive the motor to rotate. The rotary shaft of the motor causes the axial tube 26 to rotate and the water-proof brush 24 does not rotate so as to rotate the driving shaft 16. One end of the brush 19 is connected to the driving shaft 16 and another thereof is pivotally connected to the axial seat 18 of the protecting mask 14. The brush 19 is rotatable for brushing.

In the present invention, the axial tube 26 is assembled to the water-proof brush 24 which has a supporting effect. Thereby, the axial tube 26 may move straightly without shift and vibration. Thereby, the tolerance of the axial tube 26 is enhanced.

The positioning seat 20 serves for assembling a battery 21, the switch unit 22 and motor 23. The positioning seat 20 is formed as a double layer structure which can improve the tolerance of the present invention so as to prevent from damage, dislocation and deformation.

The inner and outer washers 25 and 250 are formed with an effective water-proof effect. Thereby, water in the brush 19 will not permeate into the positioning seat 20 so as to have a preferred water-proof effect.

When it is desired to clean the brush 19, the axial cover 15 of the axial tube seat 13 is detachable. It is assembled to the connecting head 12 of the casing 10 and the driving shaft 16 is inserted into the axial tube 26. Thereby, the axial cover 15 of the axial tube seat 13, the driving shaft 16 and the brush 19 can be detached so cleaning the brush 19. Likewise, if the brush 19 is worn, the brush 19 can be detached independently for updating.

Moreover, the positioning seat 20 of the present invention serves for being assembled with the motor 23 and switch unit 22. Then they are assembled into the casing 10. If it is used for a long time, it the switch unit 22 and motor 23 are necessary to be maintained. The positioning seat 20 can be drawn out directly. The whole structure is drawn out from the casing 10 so as to have a preferred effect.

Moreover, hairs of the brush 19 have round cross section. In use, the hairs rotate through the round periphery instead of rotating leftwards or rearwards (or forwards and backwards). Thereby, it has a better cleaning effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A two layered electromotive tooth brush comprising a casing, a connecting head, a positioning seat, a water-proof bush, an axial tube, an axial tube seat, an axial cover, a driving shaft and a brush; characterized in that:
a rear end of the casing has a sealing cover and a front end thereof has an inserting slot and an annular groove;
the connecting head has an enhancing piece at a rear end thereof and having a configuration with respect to a shape of the inserting groove of the casing; and an inner wall thereof is formed with annular buckling strips with a configuration with respect to the annular groove of the casing;
the positioning seat serves for installing a motor and a switch unit and then the positioning seat is assembled into the casing to be as a double layer structure;
the axial tube is assembled to a rotary shaft of the motor to be driven by the motor;
the water-proof bush having a positioning piece and a first washer which is positioned within the water-proof bush; the water-proof bush is engaged to the axial tube so as to be as a double layer structure to assist the axial tube to move along a straight line; a periphery of the water-proof bush is formed with a washer;
the axial tube seat and the axial cover are combined as an integral body; a driving shaft is mounted within the axial tube seat, a front end of the axial tube seat has a protecting mask for receiving a brush and a rear end thereof has an annular recess for receiving the connecting head;
the driving shaft is assembled to the axial tube seat and the axial cover; a front end of the driving shaft is inserted into the axial tube as to rotate therewith and a rear end of the driving shaft has a connector for assembling the brush;
the brush has a spindle; one end of the brush is inserted into the connector of the driving shaft and another end thereof is assembled into an axial seat of the protecting mask of the axial tube seat so as to be rotated by the driving shaft synchronously;
by above components, the two layered electromotive tooth brush is formed with water-proof effect.

2. The two layered electromotive tooth brush as claimed in claim 1, wherein the brush has round hairs around the spindle; the hairs rotate around a round periphery.
